(19) United States
(12) Patent Application Publication
(10) Pub. No.: US 2025/0368312 A1
(43) Pub. Date: Dec. 4, 2025

(54) STANCHION FOR AIRCRAFT STRUCTURE

(71) Applicant: The Boeing Company, Arlington, VA (US)

(72) Inventors: Michele Giachetti, Everett, WA (US); Nyi Thura, Newcastle, WA (US); Ying Shi, Saint Louis, MO (US); Wallace C. Chan, Bothell, WA (US); Hangki Lee, Shoreline, WA (US)

(73) Assignee: The Boeing Company, Arlington, VA (US)

(21) Appl. No.: 18/677,061

(22) Filed: May 29, 2024

(51) Int. Cl. B64C 1/18; B64C 1/00; B64C 1/06

(52) U.S. Cl. CPC B64C 1/18; B64C 1/068; B64C 2001/0072

(57) ABSTRACT

The stanchion for an aircraft includes a first composite body defining a first channel having a first web extending between a first pair of spaced apart flanges. The first composite body also includes a first multitude of longitudinal segments each having a ply count that varies between adjacent longitudinal segments of the first multitude of longitudinal segments. The stanchion also includes a second composite body defining a second channel having a second web extending between a second pair of flanges. The second composite body also includes a second multitude of longitudinal segments each having a ply that varies between adjacent longitudinal segments of the second plurality of longitudinal segments with the first composite body being fixed relative to the second composite body.

### BACKGROUND

The present disclosure relates generally to aircraft structures and, more specifically, to stanchions for supporting a floor system in an aircraft.

A main body of an aircraft is generally formed from fuselage segments that are joined together. The fuselage segments can include a structural framework enclosed by an outer skin. A floor structure may extend across the main body structure of the aircraft and define a portion of a passenger cabin for crew and passengers on one side and a cargo space on an opposite side. The floor structure can include floor beams that span a width of the main body of the aircraft and are attached to the structure framework.

### SUMMARY

Disclosed herein is a stanchion for an aircraft. The stanchion includes a first composite body defining a first channel having a first web extending between a first pair of spaced apart flanges. The first composite body also includes a first multitude of longitudinal segments each having a ply count that varies between adjacent longitudinal segments of the first multitude of longitudinal segments. The stanchion also includes a second composite body defining a second channel having a second web extending between a second pair of flanges. The second composite body also includes a second multitude of longitudinal segments each having a ply that varies between adjacent longitudinal segments of the second multitude of longitudinal segments with the first composite body being fixed relative to the second composite body.

In another aspect of the disclosure the ply count for each of the first multitude of longitudinal segments are symmetric about a central longitudinal segment of the first multitude of longitudinal segments.

In another aspect of the disclosure the ply count for each of the second multitude of longitudinal segments is symmetric about a central longitudinal segment of the second multitude of longitudinal segments.

In another aspect of the disclosure the stanchion includes fasteners extending through the first web and the second web.

In another aspect of the disclosure the stanchion includes a stiffening plate attached to one of the first pair of spaced apart flanges with a first fastener and attached to a corresponding one of the second pair of flanges with a second fastener.

In another aspect of the disclosure the first composite body is longitudinally offset from the second composite body.

In another aspect of the disclosure the first web includes a first attachment surface facing away from the first channel.

In another aspect of the disclosure the second web includes a second attachment surface facing away from the second channel.

In another aspect of the disclosure the stanchion includes a pivotable connection having a first pivotable attachment fixed relative to the first composite body and the second composite body at a distal end of the stanchion and a second pivotable attachment pivotably attached to the first pivotable attachment about a pivotable axis.

In another aspect of the disclosure the first web and the first pair of spaced apart flanges are a unitary structure having a C-shaped cross section and the first web includes a first surface facing into the first channel and a second surface at least partially in engagement with the second composite body.

In another aspect of the disclosure the second web and the second pair of spaced apart flanges are a unitary structure having a C-shaped cross section and the second web includes a first surface facing into the second channel and a second surface in engagement with the first composite body.

In another aspect of the disclosure the first composite body is bonded to the second composite body.

Disclosed herein is a fuselage segment. The fuselage segment includes ribs extending in a circumferential direction, stringers extending in a longitudinal direction and in engagement with ribs, floor beams extending laterally between corresponding segments of the ribs, and stanchions extending between one of the floor beams and a corresponding one of the ribs. The stanchion includes a first composite body defining a first channel having a first web extending between a first pair of spaced apart flanges. The first composite body also includes a first multitude of longitudinal segments each having a ply count that varies between adjacent longitudinal segments of the first multitude of longitudinal segments. The stanchion also includes a second composite body defining a second channel having a second web extending between a second pair of flanges. The second composite body also includes a second multitude of longitudinal segments each having a ply that varies between adjacent longitudinal segments of the second multitude of longitudinal segments with the first composite body being fixed relative to the second composite body.

In another aspect of the disclosure the ply count for each of the first multitude of longitudinal segments is symmetric about a central longitudinal segment of the first multitude of longitudinal segments and the ply count for each of the second multitude of longitudinal segments is symmetric about a central longitudinal segment of the second multitude of longitudinal segments.

In another aspect of the disclosure the stanchion includes a stiffening plate attached to one of the first pair of spaced apart flanges with a first fastener and attached to a corresponding one of the second pair of spaced apart flanges with a second fastener.

In another aspect of the disclosure the stanchion includes a pivotable connection having a first pivotable attachment fixed relative to the first composite body and the second composite body at a distal end of the multitude of stanchions and a second pivotable attachment pivotably attached to the first pivotable attachment about a pivotable axis.

In another aspect of the disclosure the first web and the first pair of spaced apart flanges are a unitary structure having a C-shaped cross section and the first web includes a first surface facing into the first channel and a second surface at least partially in engagement with the second composite body. The second web and the second pair of spaced apart flanges are a unitary structure having a C-shaped cross section and the second web includes a first surface facing into the second channel and a second surface in engagement with the first composite body.

Disclosed herein is a floor assembly for an airplane. The floor assembly includes a floor panel, at least one floor beam supporting the floor panel, at least one rib supporting opposing ends of the floor panel, at least one stanchion extending between the at least one floor beam and the at least one rib. The stanchion includes a first composite body defining a first channel having a first web extending between a first pair of spaced apart flanges. The first composite body also includes a first multitude of longitudinal segments each having a ply count that varies between adjacent longitudinal segments of the first multitude of longitudinal segments. The stanchion also includes a second composite body defining a second channel having a second web extending between a second pair of flanges. The second composite body also includes a second multitude of longitudinal segments each having a ply that varies between adjacent longitudinal segments of the second multitude of longitudinal segments with the first composite body being fixed relative to the second composite body.

In another aspect of the disclosure the ply count for each of the first multitude of longitudinal segments is symmetric about a central longitudinal segment of the first multitude of longitudinal segments and the ply count for each of the second multitude of longitudinal segments is symmetric about a central longitudinal segment of the second multitude of longitudinal segments.

In another aspect of the disclosure the first web and the first pair of spaced apart flanges are a unitary structure having a C-shaped cross section and the first web includes a first surface facing into the first channel and a second surface at least partially in engagement with the second composite body. The second web and the second pair of spaced apart flanges are a unitary structure having a C-shaped cross section and the second web includes a first surface facing into the second channel and a second surface in engagement with the first composite body.

The above summary is not intended to represent every possible embodiment or every aspect of the present disclosure. Rather, the foregoing summary is intended to exemplify some of the novel aspects and features disclosed herein. The features, functions, and advantages of the present disclosure can be achieved independently in various embodiments or may be combined in other embodiments, further details of which may be seen with reference to the following detailed description and accompanying drawings.

### BRIEF DESCRIPTION OF THE DRAWINGS

FIG. 1 illustrates an example fuselage segment having a structural framework for forming a portion of a main body of an aircraft.

FIG. 2 illustrates an enlarged view of an example stanchion of the structural framework of FIG. 1.

FIG. 3 illustrates a perspective view of the example stanchion of the structural framework of FIG. 1.

FIG. 4 illustrates a cross-sectional view of the example stanchion taken along line 4-4 of FIG. 2

FIG. 5 illustrates an enlarged view of another example stanchion of the structural framework of FIG. 1.

FIG. 6 illustrates a front perspective view of the example stanchion of FIG. 5.

FIG. 7 illustrates a rear perspective view of the example stanchion of FIG. 5.

The present disclosure is susceptible to modifications and alternative forms, with representative embodiments shown by way of example in the drawings and described in detail below. Inventive aspects of this disclosure are not limited to the disclosed embodiments. Rather, the present disclosure is intended to cover alternatives falling within the scope of the disclosure as defined by the appended claims.

### DETAILED DESCRIPTION

Embodiments of the present disclosure are described herein. It is to be understood, however, that the disclosed embodiments are illustrative examples, and that other embodiments can take various and alternative forms. The FIGS. are not necessarily drawn to scale and may be schematic. Some features may be exaggerated or minimized to show details of particular components. Therefore, specific structural and functional details disclosed herein are not to be interpreted as limiting, but merely as a representative basis for teaching one skilled in the art to variously employ the present disclosure.

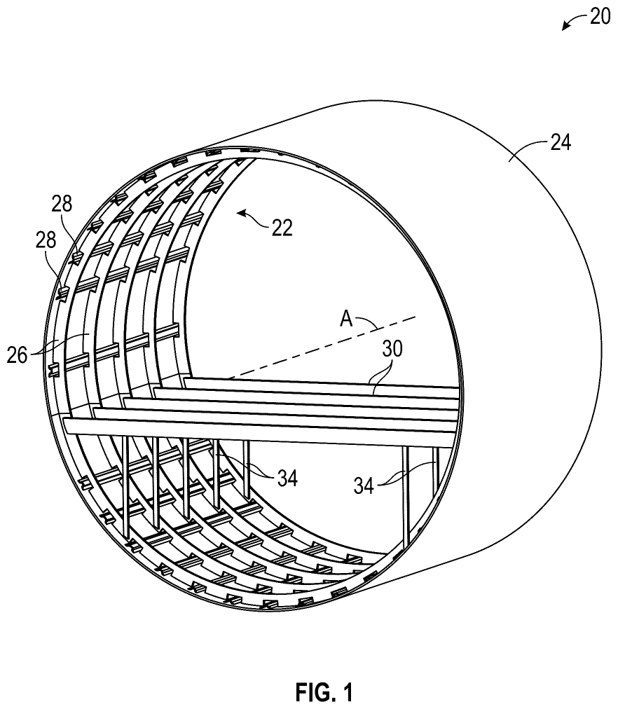

FIG. 1 illustrates a perspective view of an example fuselage segment 20. Multiple fuselage segments 20 can be joined together to form a main body of an aircraft. In the illustrated example, the fuselage segment 20 includes a structural framework 22 surrounded by a skin 24 that forms an outer surface of the fuselage segment 20. The structural framework 22 includes multiple ribs 26 that extend in a circumferential direction and are longitudinally spaced from each other relative to a longitudinal axis A of the fuselage segment 20. Stringers 28 are positioned circumferentially around the fuselage segment 20 and extend in a longitudinal direction for engaging the ribs 26 in the fuselage segment 20.

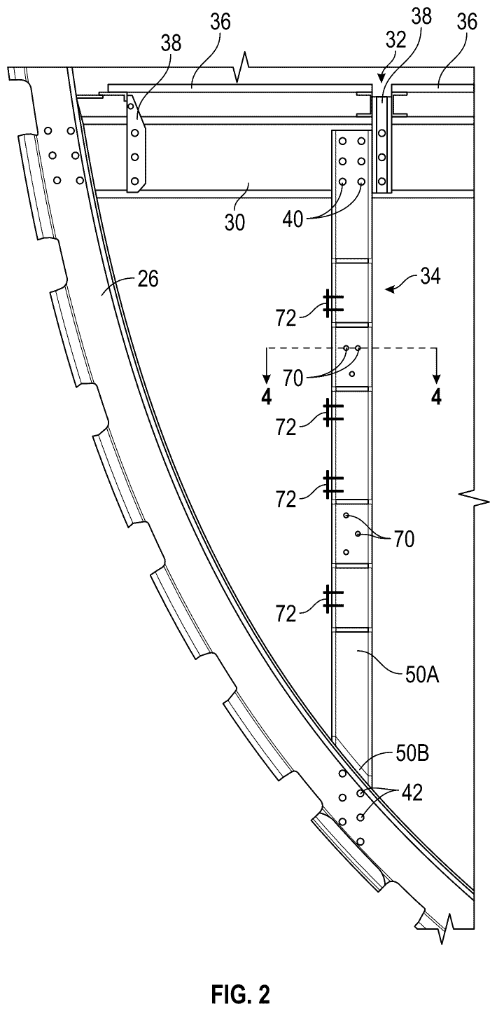

Floor beams 30 extend laterally across the fuselage segment 20 between corresponding ribs 26 to support a floor system 32 (FIG. 2). In the illustrated example, a pair of stanchions 34 engage each the floor beam 30 and a corresponding one of the ribs 26 that are longitudinally aligned with a corresponding one of the floor beams 30 In this disclosure, axial or axially, radial or radially, and longitudinal or longitudinally, are relative to the axis A of the fuselage segment 20.

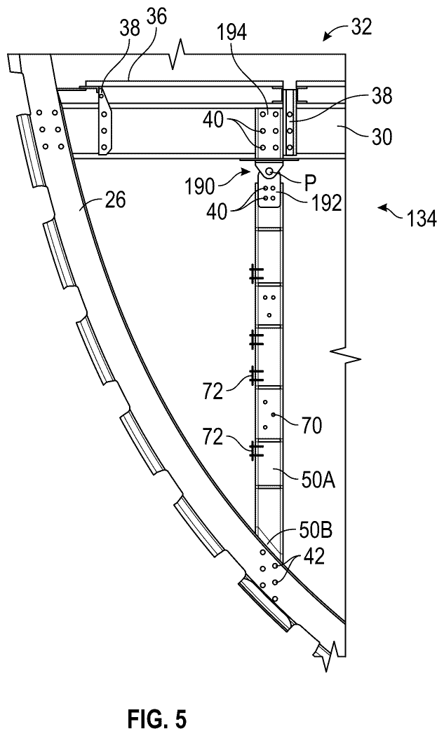

FIG. 2 illustrates an enlarged view of one of the stanchions 34 extending between one of the floor beams 30 and one of the ribs 26. In the illustrated example, the stanchion 34 is fastened directly to the floor beam 30 at a first end with fasteners 40 and fastened directly to the rib 26 at a second end with fasteners 42. While the stanchion 34 is shown in direct engagement with the floor beam 30 and the rib 26, the stanchion 34 can engage additional structures, such as the stringers 28 or a pivot connection (FIG. 5). Floor panels 36 are supported by the floor beams 30 with brackets 38 that form at least a portion of the flooring system 32. The floor panels 36 at least partially separate a passenger compartment on the aircraft from a cargo compartment.

As shown in FIGS. 2-4, each of the stanchions 34 is formed from a first channel 50A attached in a back-to-back configuration with a second channel 50B. In the illustrated example, the first and second channels 50A and 50B are comprised of a composite material formed from multiple plies or layers of a fibrous material, such as a carbon fiber weave material, supported in a resin such that the first and second channels 50A and 50B form a first and second composite body, respectively. Each of the first and second channels 50A and 50B can be formed in a mold having a variable number of plies along its length as discussed in greater detail below.

The first and second channels 50A and 50B extend longitudinally between first ends 52A and 52B and second ends 54A and 54B, respectively. The first and second channel 50A and 50B are longitudinally offset relative to each other such that the first end 52A of the first channel 50A and the first end 52B of the second channel 50B are in a non-overlapping configuration. Similarly, the second end 54A of the first channel 50A and the second end 54B of the second channel 50B are also in a non-overlapping configuration. Accordingly, this forms a central region of the stanchion 34 having a double wall defined by the first channel 50A and the second channel 50B. In one example, the first and second channels 50A and 50B are mirror images of each other.

Each of the first and second channels 50A and 50B include a first and second web 60A and 60B that extends between a first and second pair of spaced apart flanges 62A and 62B, respectively, as a unitary structure. The first and second channels 50A and 50B each include a first and second inner surface 64A and 64B that face into a corresponding channel region and a first and second outer surface 66A and 66B, respectively, that face outward from the channel region and at least partially towards the other channel.

When the first and second channels 50A and 50B are formed, each ply or layer of the composite structure extends continuously from the first and second webs 60A and 60B through to outer edges of the first and second pair of spaced apart flanges 62A and 62B, respectively. Furthermore, one or both outer surfaces 66A and 66B can include a joining layer 39 in the region of the first and second web 60A and 60B molded therein to aid in bonding the first and second channels 50A and 50B, respectively, to each other. In one example, the joining layer 39 is active through an application of heat and pressure applied to one or both first and second channels 50A and 50B. The joining layer 39 can be comprised of a thermoplastic film.

In one example, the channels 50A and 50B are composite structures formed from multiple layers of material that are formed into the C-shaped configuration through the application of heat and pressure by a mold during a molding process or a stamping process. Each of the channels 50A and 50B include a set of multiple plies that extend continuously between the first ends 52A and 52B to the second ends 54A and 54B, respectively.

While the channels 50A and 50B include sets of continuous plies as described above, each channel 50A and 50B can include longitudinal segments extending in a lengthwise direction relative to the first ends 52A and 52B and second ends 54A and 54B where a number of plies varies. For example, additional plies can be added to certain longitudinal segments of the first and second channels 50A and 50B in a predetermined pattern of ply thicknesses. In the illustrated example, each of the channels 50A and 50B include opposing end longitudinal segments S-E that include a minimum number of plies that extend between the first ends 52A and 52B and the second ends 54A and 54B, respectively. The first and second channels 50A and 50B also include longitudinal segments S-1, S-2, and S-3 where ply count can vary between adjacent longitudinal segments. In this disclosure, the ply count is determined by a number of layers or plies of material that are stacked on each other when forming the channels 50A and 50B. Although the illustrated example includes the longitudinal segments S-E, S-1, S-2, and S-3, fewer longitudinal segments, such as three longitudinal segments, or more longitudinal segments, such as five longitudinal segments, can be utilized in this disclosure based on a given application and length of the stanchion 34.

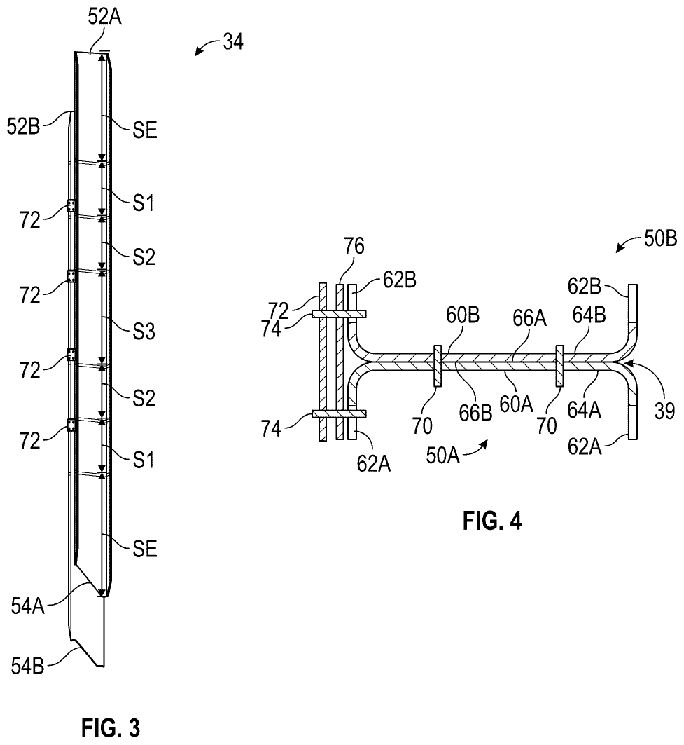

As illustrated in FIG. 3, the longitudinal segments S-E, S-1, and S-2 are arranged symmetrically about the longitudinal segment S-3. Therefore, the longitudinal segment S-3 in the illustrated example is a central longitudinal segment of the stanchion 34 such that the longitudinal segment S-3 includes an equal number of longitudinal segments between first ends 52A and 52B and second ends 54A and 54B. Furthermore, in one example, at least a portion of the central longitudinal segment is located at a midpoint that is equidistant from the first ends 52A and 52B and the second ends 54A and 54B.

In the illustrated example, the longitudinal segment S-1 includes a first number of plies, the longitudinal segment S-2 includes a second number of plies, and the longitudinal segment S-3 includes a third number of plies. Additionally, one of the inner longitudinal segments S-2 or S-3 can include the same number of plies as the end longitudinal segment S-E. For example, longitudinal segments S-E and S-2 can each include eight plies, longitudinal segment S-1 can include ten plies, and section S-3 can include twelve plies. One feature of having a variable number of plies between the longitudinal segments is the ability to control energy dissipation in the stanchion 34 during high load scenarios. One example high load scenario may include landing an aircraft on its belly during a failure of one or more landing gear on the aircraft.

Furthermore, as shown in FIGS. 2-4, the first and second channels 50A and 50B can be secured to each other with mechanical fasteners in addition to the bonding that occurs between the first and second channels 50A and 50B. In one example, mechanical fasteners 70, such as bolts, can extend through the first and second webs 60A and 60B and apply a compressive force to first and second channels 50A and 50B. Additionally, the mechanical fasteners 70 can restrict the first and second channels 50A and 50B from moving longitudinally relative to each other.

As shown in FIG. 4, a stiffening plate 72 can also be used to secure the first and second channels 50A and 50B to each other and improve load distribution. In the illustrated example, the stiffening plate 72 is planar and is comprised of a metallic material or a composite material. In one example, the stiffening plate 72 attaches to a corresponding one of each of the pair of spaced apart webs 62A and 62B. The stiffening plate 72 is attached to the first and second channels 50A and 50B with mechanical fasteners 74, such as bolts. The stiffening plate 72 can be further secured to the first and second channels 50A and 50B with an adhesive member 76 located between the stiffening plate 72 and the corresponding one of each of the pair of spaced apart flanges 62A and 62B.-The adhesive member 76 can be used in addition to or in place of the fasteners 74.

FIGS. 5-7 illustrate an example stanchion 134 that is similar to the stanchion 34 except where described below or shown in the drawings. Similar or like components will include the addition of a leading “1.”

As shown in FIG. 5, the stanchion 134 extends between the ribs 26 of the fuselage 20 and the floor beam 30. While the connection between the stanchion 134 and the ribs 26 is identical to the connection between the stanchion 34 and the ribs 26, the connection between the stanchion 134 and the floor beam 30 includes a pivotable connection 190. The pivotable connection 190 includes a first pivotable attachment 192 fixed relative to the stanchion 134 with the fasteners 40 and a second pivotable attachment 194 fixed relative to the floor beam 30 with the fasteners 40. In the illustrated example, the first and second pivotable attachments 192 and 194 are joined together about a pivotable axis P through a pivot, such as a pin, extending through the first and second pivotable attachments 192 and 194.

One feature of the first pivotable attachment 192 is that it is secured to a double thickness of the stanchion 134 with fasteners 40 extending through both the first and second channels 150A and 150B. Furthermore, in the illustrated example, the first and second channels 150A and 150B do not mirror each other like the first and second channels 50A and 50B of the stanchion 34. Rather, the first channel 150A is shorter in length than the second channel 150B to allow the second channel 150B to be attached to the ribs 26 with the fasteners 42.

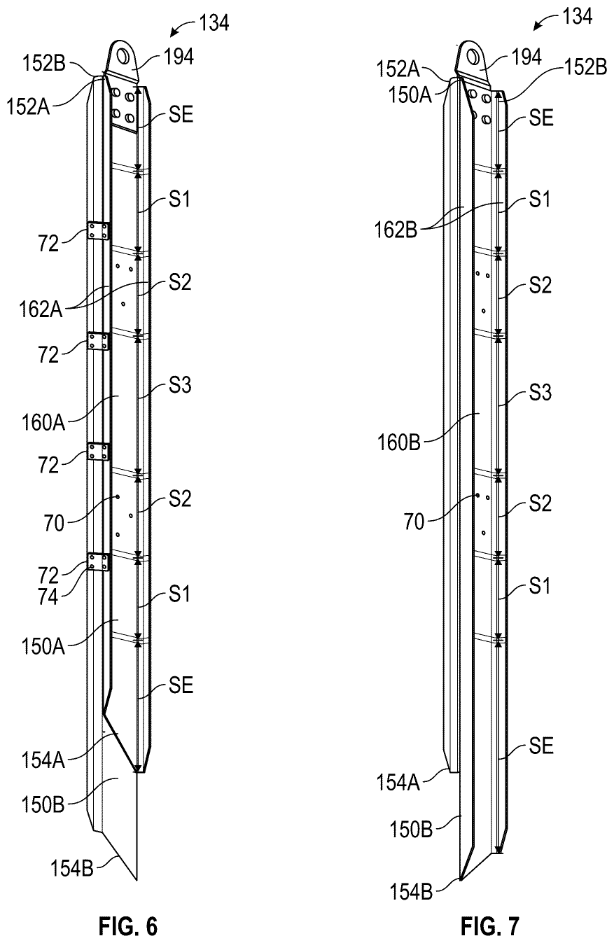

As shown in FIGS. 6-7, the channels 150A and 150B include sets of continuous plies extending between opposing first ends 152A and 152B and second ends 154A and 154B. The first and second channels 150A and 150B also includes a first and second web 160A and 160B that extends between a first and second pair of spaced apart flanges 162A and 162B, respectively, as a unitary structure. Also, each channel 150A and 150B can include longitudinal segments, such as the longitudinal segments S-E, S-1, S-2, and S-3, with a varying number of plies. The number of plies can vary by adding additional plies to the base number of plies that extend between first ends 152A and 152B and opposing second ends 154A and 154B of the channels 150A and 150B, respectively.

Furthermore, as shown in FIGS. 5-7, the first and second channels 150A and 150B can be secured to each other with mechanical fasteners in addition to the bonding that occurs between the first and second channels 150A and 150B. In one example, mechanical fasteners 70, such as bolts, can extend through the first and second webs 160A and 160B as with the stanchion 34. The first and second channels 150A and 150B can be secured relative to each other with the stiffening plate 72 and fasteners 74 as described above with respect to the stanchion 34.

The following Clauses provide example configurations of the stanchion 34, 134 as shown in the FIGS.

Clause 1: A stanchion for an aircraft, comprising: a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

Clause 2: The stanchion of clause 1, wherein the ply count for each of the first plurality of longitudinal segments is symmetric about a central longitudinal segment of the first plurality of longitudinal segments.

Clause 3: The stanchion of clauses 1-2, wherein the ply count for each of the second plurality of longitudinal segments is symmetric about a central longitudinal segment of the second plurality of longitudinal segments.

Clause 4: The stanchion of clauses 1-3, including a plurality of fasteners extending through the first web and the second web.

Clause 5: The stanchion of clauses 1-4, including a stiffening plate attached to one of the first pair of spaced apart flanges with a first fastener and attached to a corresponding one of the second pair of spaced apart flanges with a second fastener.

Clause 6: The stanchion of clauses 1-5, wherein the first composite body is longitudinally offset from the second composite body.

Clause 7: The stanchion of clauses 1-6, wherein the first web includes a first attachment surface facing away from the first channel.

Clause 8: The stanchion of clauses 1-7, wherein the second web includes a second attachment surface facing away from the second channel.

Clause 9: The stanchion of clauses 1-8, including a pivotable connection having a first pivotable attachment fixed relative to the first composite body and the second composite body at a distal end of the stanchion and a second pivotable attachment pivotably attached to the first pivotable attachment about a pivotable axis.

Clause 10: The stanchion of clauses 1-9, wherein the first web and the first pair of spaced apart flanges are a unitary structure having a C-shaped cross section and the first web includes a first surface facing into the first channel and a second surface at least partially in engagement with the second composite body.

Clause 11: The stanchion of clauses 1-10, wherein the second web and the second pair of spaced apart flanges are a unitary structure having a C-shaped cross section and the second web includes a first surface facing into the second channel and a second surface in engagement with the first composite body.

Clause 12: The stanchion of clauses 1-12, wherein the first composite body is bonded to the second composite body.

Clause 13: A fuselage segment, comprising: a plurality of ribs extending in a circumferential direction; a plurality of stringers extending in a longitudinal direction and in engagement with the plurality of ribs; a plurality of floor beams extending laterally between corresponding segments of the plurality of ribs; and a plurality of stanchions extending between one of the plurality of floor beams and a corresponding one of the plurality of ribs, wherein each of the plurality of stanchions include: a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

Clause 14: The fuselage segment of clause 13, wherein the ply count for each of the first plurality of longitudinal segments is symmetric about a central longitudinal segment of the first plurality of longitudinal segments and the ply count for each of the second plurality of longitudinal segments is symmetric about a central longitudinal segment of the second plurality of longitudinal segments.

Clause 15: The fuselage segment of clauses 13-14, including a stiffening plate attached to one of the first pair of spaced apart flanges with a first fastener and attached to a corresponding one of the second pair of spaced apart flanges with a second fastener.

Clause 16: The fuselage segment of clauses 13-15, including a pivotable connection having a first pivotable attachment fixed relative to the first composite body and the second composite body at a distal end of the plurality of stanchions and a second pivotable attachment pivotably attached to the first pivotable attachment about a pivotable axis.

Clause 17: The fuselage segment of clauses 13-16, wherein the first web and the first pair of spaced apart flanges are a unitary structure having a C-shaped cross section and the first web includes a first surface facing into the first channel and a second surface at least partially in engagement with the second composite body; and wherein the second web and the second pair of spaced apart flanges are a unitary structure having a C-shaped cross section and the second web includes a first surface facing into the second channel and a second surface in engagement with the first composite body.

Clause 18: A floor assembly for an airplane, comprising: a floor panel; at least one floor beam supporting the floor panel; at least one rib supporting opposing ends of the floor panel; at least one stanchion extending between the at least one floor beam and the at least one rib, wherein the at least one stanchion includes: a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

Clause 19: The floor assembly of clause 18, wherein the ply count for each of the first plurality of longitudinal segments is symmetric about a central longitudinal segment of the first plurality of longitudinal segments and the ply count for each of the second plurality of longitudinal segments is symmetric about a central longitudinal segment of the second plurality of longitudinal segments.

Clause 20: The floor assembly of clauses 18-19, wherein the first web and the first pair of spaced apart flanges are a unitary structure having a C-shaped cross section and the first web includes a first surface facing into the first channel and a second surface at least partially in engagement with the second composite body; and wherein the second web and the second pair of spaced apart flanges are a unitary structure having a C-shaped cross section and the second web includes a first surface facing into the second channel and a second surface in engagement with the first composite body.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

What is claimed is:

1. A stanchion for an aircraft, comprising:
a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and
a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

2. The stanchion of claim 1, wherein the ply count for each of the first plurality of longitudinal segments is symmetric about a central longitudinal segment of the first plurality of longitudinal segments.

3. The stanchion of claim 1, wherein the ply count for each of the second plurality of longitudinal segments is symmetric about a central longitudinal segment of the second plurality of longitudinal segments.

4. The stanchion of claim 1, including a plurality of fasteners extending through the first web and the second web.

5. The stanchion of claim 1, including a stiffening plate attached to one of the first pair of spaced apart flanges with a first fastener and attached to a corresponding one of the second pair of flanges with a second fastener.

6. The stanchion of claim 1, wherein the first composite body is longitudinally offset from the second composite body.

7. The stanchion of claim 6, wherein the first web includes a first attachment surface facing away from the first channel.

8. The stanchion of claim 6, wherein the second web includes a second attachment surface facing away from the second channel.

9. The stanchion of claim 1, including a pivotable connection having a first pivotable attachment fixed relative to the first composite body and the second composite body at a distal end of the stanchion and a second pivotable attachment pivotably attached to the first pivotable attachment about a pivotable axis.

10. The stanchion of claim 1, wherein the first web and the first pair of spaced apart flanges are a unitary structure having a C-shaped cross section and the first web includes a first surface facing into the first channel and a second surface at least partially in engagement with the second composite body.

11. The stanchion of claim 10, wherein the second web and the second pair of spaced apart flanges are a unitary structure having a C-shaped cross section and the second web includes a first surface facing into the second channel and a second surface in engagement with the first composite body.

12. The stanchion of claim 1, wherein the first composite body is bonded to the second composite body.

13. A fuselage segment, comprising:
a plurality of ribs extending in a circumferential direction;
a plurality of stringers extending in a longitudinal direction and in engagement with the plurality of ribs;
a plurality of floor beams extending laterally between corresponding segments of the plurality of ribs; and
a plurality of stanchions extending between one of the plurality of floor beams and a corresponding one of the plurality of ribs, wherein each of the plurality of stanchions include:
a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and
a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

14. The fuselage segment of claim 13, wherein the ply count for each of the first plurality of longitudinal segments is symmetric about a central longitudinal segment of the first plurality of longitudinal segments and the ply count for each of the second plurality of longitudinal segments is symmetric about a central longitudinal segment of the second plurality of longitudinal segments.

15. The fuselage segment of claim 13, including a stiffening plate attached to one of the first pair of spaced apart flanges with a first fastener and attached to a corresponding one of the second pair of flanges with a second fastener.

16. The fuselage segment of claim 13, including a pivotable connection having a first pivotable attachment fixed relative to the first composite body and the second composite body at a distal end of the plurality of stanchions and a second pivotable attachment pivotably attached to the first pivotable attachment about a pivotable axis.

17. The fuselage segment of claim 13, wherein the first web and the first pair of spaced apart flanges are a unitary structure having a C-shaped cross section and the first web includes a first surface facing into the first channel and a second surface at least partially in engagement with the second composite body; and
wherein the second web and the second pair of spaced apart flanges are a unitary structure having a C-shaped cross section and the second web includes a first surface facing into the second channel and a second surface in engagement with the first composite body.

18. A floor assembly for an airplane, comprising:
a floor panel;
at least one floor beam supporting the floor panel;
at least one rib supporting opposing ends of the floor panel;
at least one stanchion extending between the at least one floor beam and the at least one rib, wherein the at least one stanchion includes:
a first composite body defining a first channel having a first web extending between a first pair of spaced apart flanges, wherein the first composite body includes a first plurality of longitudinal segments each having a ply count that varies between adjacent longitudinal segments of the first plurality of longitudinal segments; and
a second composite body defining a second channel having a second web extending between a second pair of flanges, wherein the second composite body includes a second plurality of longitudinal segments each having a ply that varies between adjacent longitudinal segments of the second plurality of longitudinal segments and the first composite body is fixed relative to the second composite body.

19. The floor assembly of claim 18, wherein the ply count for each of the first plurality of longitudinal segments is symmetric about a central longitudinal segment of the first plurality of longitudinal segments and the ply count for each of the second plurality of longitudinal segments is symmetric about a central longitudinal segment of the second plurality of longitudinal segments.

20. The floor assembly of claim 18, wherein the first web and the first pair of spaced apart flanges are a unitary structure having a C-shaped cross section and the first web includes a first surface facing into the first channel and a second surface at least partially in engagement with the second composite body; and
wherein the second web and the second pair of spaced apart flanges are a unitary structure having a C-shaped cross section and the second web includes a first surface facing into the second channel and a second surface in engagement with the first composite body.
